(19) United States
(12) Patent Application Publication
(10) Pub. No.: US 2023/0121810 A1
(43) Pub. Date: Apr. 20, 2023

(54) Solid-State Manufacturing System And Process Suitable For Extrusion, Additive Manufacturing, Coating, Repair, Welding, Forming, And Material Fabrication

(71) Applicant: THE REGENTS OF THE UNIVERSITY OF MICHIGAN, Ann Arbor, MI (US)

(72) Inventors: Fengchao LIU, Ann Arbor, MI (US); Pingsha DONG, Ann Arbor, MI (US)

(21) Appl. No.: 17/984,306

(22) Filed: Nov. 10, 2022

Related U.S. Application Data
(63) Continuation of application No. 16/931,744, filed on Jul. 17, 2020.
(60) Provisional application No. 62/889,168, filed on Aug. 20, 2019.

(51) Int. Cl. B29C 64/209; B29C 48/475; B29C 48/465; B29C 48/395; B22F 3/20; B33Y 30/00; B33Y 10/00; B29C 48/06; B29C 64/141

(52) U.S. Cl. CPC B29C 64/209; B22F 3/20; B29C 48/06; B29C 48/397; B29C 48/467; B29C 48/475; B29C 64/141; B33Y 10/00; B33Y 30/00

(57) ABSTRACT

A solid-state manufacturing method comprising urging a metal-based feedstock material within a sleeve of a propulsion system in a processing direction along an axis of the sleeve and against a friction die adjacent one end of the sleeve; softening at least a portion of the feedstock material within the hollow portion of the sleeve to a malleable state to form malleable feedstock material using relative rotatory friction between the friction die and the feedstock material; extruding the malleable feedstock material from an extrusion hole in response to the urging step; and depositing the malleable feedstock material from the extrusion hole onto a substrate as a paste using at least one plastering surface and continuing depositing the malleable feedstock material as deposit layers until a desired shape is completed.

### CROSS-REFERENCE TO RELATED APPLICATIONS

This application is a continuation of U.S. Pat. Application No. 16/931,744 filed on Jul. 17, 2020, which claims the benefit of U.S. Provisional Application No. 62/889,168, filed on Aug. 20, 2019. The entire disclosure of the above application is incorporated herein by reference.

### FIELD

The present disclosure relates to solid-state manufacturing and, more particularly, relates to solid-state manufacturing systems and processes employing friction energy to locally soften material for extrusion, additive manufacturing, coating, repair, welding, forming, and material fabrication.

### BACKGROUND AND SUMMARY

This section provides background information related to the present disclosure which is not necessarily prior art. This section provides a general summary of the disclosure and is not a comprehensive disclosure of its full scope or all its features.

Additive manufacturing (AM) has brought digital flexibility and material usage efficiency to manufacturing operations and has demonstrated the potential for revolutionizing product design and fabrication on a global scale. The term “additive manufacturing” refers to technologies that build three-dimensional substrates one layer at a time. Each successive layer bonds to the preceding layer of material. For many applications, additive manufacturing delivers a perfect trifecta of improved performance, optimum geometry, and free-form fabrication.

Despite the success of AM in some high-value applications, significant gaps still exist in fusion-based metal AM. For instance, fusion-based AM is still a low-speed, high-cost manufacturing process. Porosity and loss of alloying elements have not been overcome in fusion-based metal AM. Due to epitaxial solidification, fusion-based AM typically produces highly orientated, columnar grains with anisotropic mechanical properties that may not be suited for some structural applications.

The limitations associated with fusion-based AM can be solved to a certain extent by solid-state additive manufacturing, e.g. MELD, which is a solid-state AM process (see U.S. Pat. Publication No. 2008/0041921). MELD has shown its advantages compared to fusion-based AM.

However, one limitation in MELD is that it needs to bring the material to a malleable state between the deposition shoulder and the deposition layer. This requires the application of high forging force against the deposition region. For multiple layer deposition, a later layer to be deposited can only be done after a certain period of time to allow the preceding layer to gain sufficient strength to sustain the high forging force. This significantly reduces manufacturing speed. In addition, MELD cannot be used for local surfacing or repairing thin wall structures without sufficient back support.

The Solid-State Additive Manufacturing Process of the present teachings (generally referred to as “SoftTouch” and used herein to denote the present teachings) is novel and overcomes the aforementioned limitations with the following process steps employed in some embodiments: (1) bring material to malleable state prior to deposition through friction between the feedstock material and a friction die; (2) extrude malleable feedstock material out through an extrusion hole as a paste onto a substrate; and (3) continue to deposit until a desired shape is completed. As the feedstock material has been softened to a malleable state prior to deposition, a very high forging force on the deposition substrate or the previously deposited material is not needed during the deposition, enabling high deposition speed without the required waiting time between layers of conventional systems. The local softening of the filler material is caused by the local heating and microstructure refinement. As the deposition material is in a malleable state during deposition without melting, the deposit layers are fully dense, ensuring good mechanical properties.

To achieve the function of SoftTouch deposition mentioned above, SoftTouch solid-state additive manufacturing systems and methods are provided in accordance with the teachings herein. The simplest version of a SoftTouch solid-state additive manufacturing system and method can comprise a sleeve for constraining feedstock material, a friction die at one end of the sleeve, a propulsion system operably coupled to the sleeve, an extrusion hole that permits the feedstock material within the sleeve to be extruded out and a deposition surface for shaping the deposited material. The friction die and the sleeve can rotate relative with each other, but do not need a relative movement along the rotational axis direction between them. The propulsion system enables the feedstock material to be rotated relative to the die and, in some embodiments, move relative to the die along the rotational axis direction. During deposition, the relative rotation between the friction die and the feedstock material within the sleeve results in frictional heating of the feedstock materials and, thus, brings the feedstock material to a malleable state prior to deposition. The malleable feedstock material is extruded out through the extrusion hole under the pushing of the propulsion system or other suitable system. The extruded material is deposited onto a deposition surface of the substrate until a desired shape is achieved.

In addition to additive manufacturing, in some embodiments, the SoftTouch solid-state additive manufacturing systems and methods of the present teachings can be used for coating, repair, and/or welding.

In some embodiments, the SoftTouch solid-state additive manufacturing systems and methods can be used for extrusion, thermomechanical processing, material recycling, and material preparation, and new material fabrication.

In some embodiments, the self-energized extrusion systems developed for SoftTouch can comprise a sleeve for constraining feedstock material, a friction die at one end of the sleeve, a propulsion system operably coupled to the sleeve, and an extrusion hole that permits the feedstock material within the sleeve to be extruded out. The friction die and the sleeve can rotate relative to each other, but without a relative movement along the rotational axis direction between them. The propulsion system enables the feedstock material to move relative to the friction die along the rotational axis direction. During extrusion, the relative rotation between the friction die and the feedstock material within the sleeve results in frictional heating of the feedstock materials and, thus, brings the feedstock material to a malleable state prior to extrusion. The malleable feedstock material is extruded out of an extrusion hole under the pushing of the propulsion system or other suitable system.

For the self-energized extrusion systems and methods, the friction die and the sleeve rotate relative with each other but without a relative movement along the rotational axis direction between them. This is different from direct extrusion system and friction extrusion system. In direct extrusion system, the extrusion die does not rotate relative to the sleeve at all. In friction extrusion, the friction die and the sleeve rotate relative to each other and also move relative to each other along the tool rotation direction.

Further areas of applicability will become apparent from the description provided herein. The description and specific examples in this summary are intended for purposes of illustration only and are not intended to limit the scope of the present disclosure.

### DRAWINGS

The patent or application file contains at least one drawing executed in color. Copies of this patent or patent application publication with color drawing(s) will be provided by the Office upon request and payment of the necessary fee.

The drawings described herein are for illustrative purposes only of selected embodiments and not all possible implementations, and are not intended to limit the scope of the present disclosure.

FIG. 1 is a cross-sectional view of a Locally Energized Extrusion system having a sleeve, propulsion system, friction die, and extrusion hole according to the principles of the present teachings. The die and the sleeve rotate relative to each other, but do not need a relative movement along the rotational axis direction between them. The propulsion system, including a push ram, enables moving the feedstock material within the sleeve toward the die along the rotational axis direction. The feedstock material is locally heated by the relative rotation between the feedstock material and the friction die and then is extruded out of the sleeve through one extrusion hole in the friction die.

FIG. 2 is a cross-sectional view of another version of a Locally Energized Extrusion system, in which the pinch roller serves as the propulsion system.

FIG. 3 is a cross-sectional view of another version of a Locally Energized Extrusion system, in which the rotating screw serves as the propulsion system when feedstock material is in particle form.

FIG. 4 is a cross-sectional view of another version of a Locally Energized Extrusion system, showing how the feedstock material particles can be fed into the sleeve.

FIG. 5 is a cross-sectional view of another version of a Locally Energized Extrusion system, showing multiple extrusion holes in a friction die.

FIG. 6 is a cross-sectional view of another version of a Locally Energized Extrusion system, showing the extrusion hole is in the sleeve wall.

FIG. 7 is a cross-sectional view of another version of a Locally Energized Extrusion system, showing the extrusion hole is not straight.

FIG. 8 is a cross-sectional view of another version of a Locally Energized Extrusion system, showing a chamfer formed on the extrusion hole.

FIG. 9 is a cross-sectional view of another version of a Locally Energized Extrusion system, showing one end of the sleeve sits on the surface of a friction die.

FIG. 10 is a side cross-sectional view of another version of a Locally Energized Extrusion system, showing one end of the sleeve sits in a friction die.

FIG. 11 is a cross-sectional view of another version of a Locally Energized Extrusion system, showing parts of the sleeve die are in the sleeve.

FIG. 12 shows a cross-sectional view of a secondary material processing system was added to the Locally Energized Extrusion, generating a new series of solid-state manufacturing systems and methods.

FIG. 13 shows a cross-sectional view of a SoftTouch deposition system having one sleeve, one propulsion system, one friction die, one extrusion hole and one friction surface. The malleable feedstock material extruded out of the extrusion hole was deposited on a substrate surface layer by layer.

FIG. 14 shows a cross-sectional view of a SoftTouch deposition system that deposits a layer of material into a defect (slot) of on a substrate.

FIG. 15 shows a cross-sectional view of a SoftTouch deposition system that deposits material into a gap between components A and B.

FIGS. 16A-16F shows a cross-sectional view of different kind of joints produced by a SoftTouch deposition system.

FIG. 17 shows a cross-sectional view of a SoftTouch deposition system that deposits a layer of material on a substrate surface through an extrusion hole in the sleeve wall.

FIG. 18 shows a cross-sectional view of a SoftTouch deposition system with a forming tool located in between the friction die and the deposited material.

FIG. 19 shows a cross-sectional view of a SoftTouch deposition system that uses a forming tool to improve the surface quality of the joint produced.

FIG. 20 shows a cross-sectional view of a SoftTouch deposition system with a forming tool located in between the sleeve and the deposited material.

FIG. 21 shows a top view of a SoftTouch deposition system with a forming tool following a deposition system to join two components together.

FIG. 22 shows a cross-sectional view of a SoftTouch deposition system with a forming tool following a deposition system to deposit multiple layers of material on a substrate.

FIG. 23 is an example embodiment showing how a ram can apply push force F₁ on filler material while a pull force F₂ is applied in an opposite direction to reduce the overall forcing force applied on deposition layers.

FIG. 24 is an example embodiment showing how a roller can apply push force F₁' on wire filler material while a pull force F₂' can be applied in an opposite direction to reduce the overall forcing force applied on deposition layers.

FIG. 25 is an example embodiment showing how the hopper can be used to continuously send feedstock material into the sleeve and then deposit the extruded material on a substrate using an optional forming tool.

FIG. 26 shows a cross-sectional view of a secondary thermomechanical processing system added to the Locally Energized Extrusion, generating a new series of solid-state manufacturing systems and methods.

FIG. 27 shows a cross-sectional view of the feedstock material particles extruded out by the Locally Energized Extrusion system and then further processed by a secondary rolling system.

FIG. 28 shows a cross-sectional view of the feedstock material particles extruded out by the Locally Energized Extrusion system and then further processed by a secondary extrusion system.

FIG. 29 shows the possible cross-sections of the extruded components using the technologies in the present teaching.

FIG. 30 shows a produced sample using a SoftTouch deposition having a layer of aluminum alloy deposited on a steel surface.

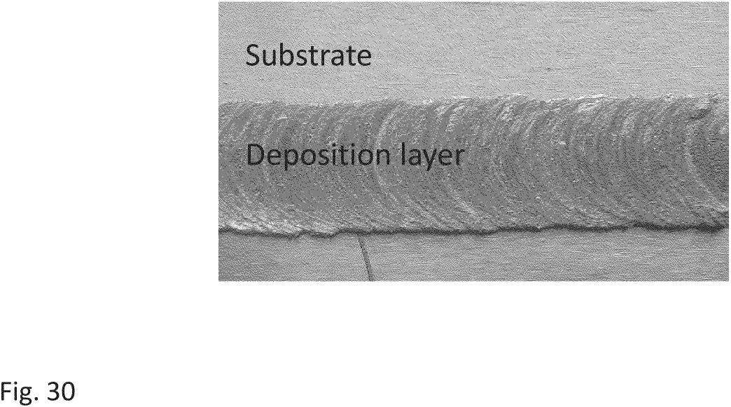

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature’s relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

According to the principles of the present teachings, a solid-state manufacturing process is provided having advantageous construction and operation that can be used for, but not limited to, extrusion, additive manufacturing, coating, joining, repairing, forming, material processing, material recycling, and material fabrication.

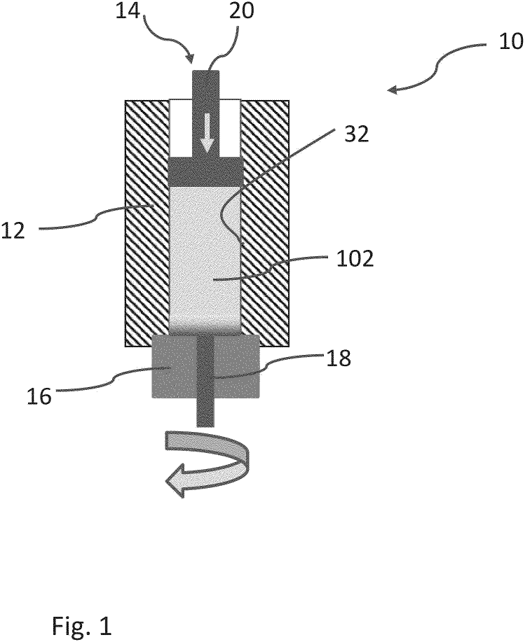

In some embodiments, as illustrated in FIG. 1, a solid-state manufacturing system 10 and method that enables “Locally-energized Extrusion” includes at least one sleeve 12 for constraining feedstock material 102, a propulsion system 14 (in some embodiments disposed at a first end of the sleeve 12), a friction die 16 (in some embodiments disposed at an opposing end of the sleeve 12), and at least one extrusion hole, channel, or orifice 18 that permits the feedstock material 102 within the sleeve 12 to be extruded out. The friction die 16 and the sleeve 12 rotate relative to each other, but without a relative movement along the rotational axis direction between them. The propulsion system 14 moves the feedstock material 102 toward the friction die 16 along the rotational axis direction. During processing, the relative friction between the friction die 16 and the feedstock material 102 within the sleeve 12 locally heats up the feedstock material 102 and brings the feedstock material 102 to a malleable state prior to extrusion. The malleable feedstock material 102 is extruded out of the sleeve 12 through at least one extrusion hole 18 under the pushing of the propulsion system 14.

In some embodiments, the friction die 16 is rotated by a motor, while the sleeve 12 does not rotate. In some embodiments, the sleeve 12 is rotated by a motor while the friction die 16 does not rotate. In some embodiments, the sleeve 12 and the friction die 16 are driven by different motors and rotate at different rates. In some embodiments, the friction die 16 and the sleeve 12 solely rotate relative to each other.

In some embodiments, as illustrated in FIG. 1, the propulsion system 14 can be disposed at a first end of the sleeve 12 and the propulsion system 14 can comprise at least one push ram 20 that is configured to push the feedstock material 102 toward the friction die 16 in the direction of the arrow. In some embodiments, an anti-rotation key is added at the end of the push ram 20 to avoid the relative rotation between the feedstock material 102 and the push ram 20.

In some embodiments, the push ram 20 can be derived by any conventional mechanical and hydraulic means. In some embodiments, the push ram 20 is derived by a hydraulic servo system.

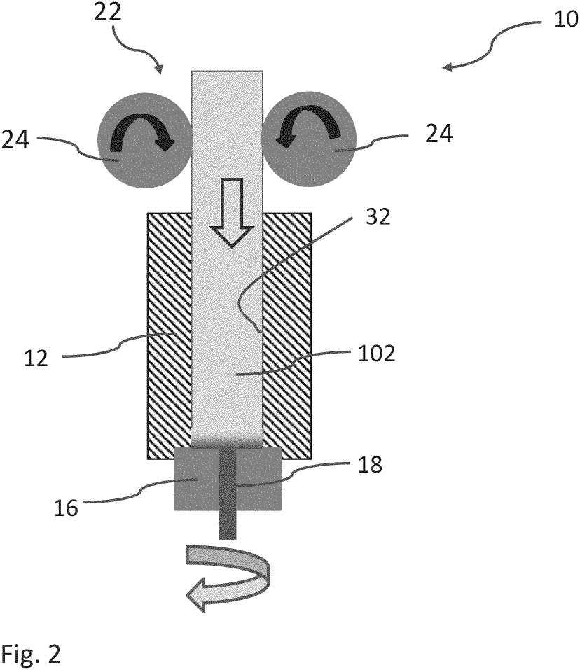

In some embodiments, the propulsion system 14 can comprise a rolling system 22 that can push the feedstock material 102 toward the friction die 16. In some embodiments, as illustrated in FIG. 2, the propulsion system 14 can comprise at least a pair of pinch rollers 24 that can push the feedstock material 102 toward the friction die 16.

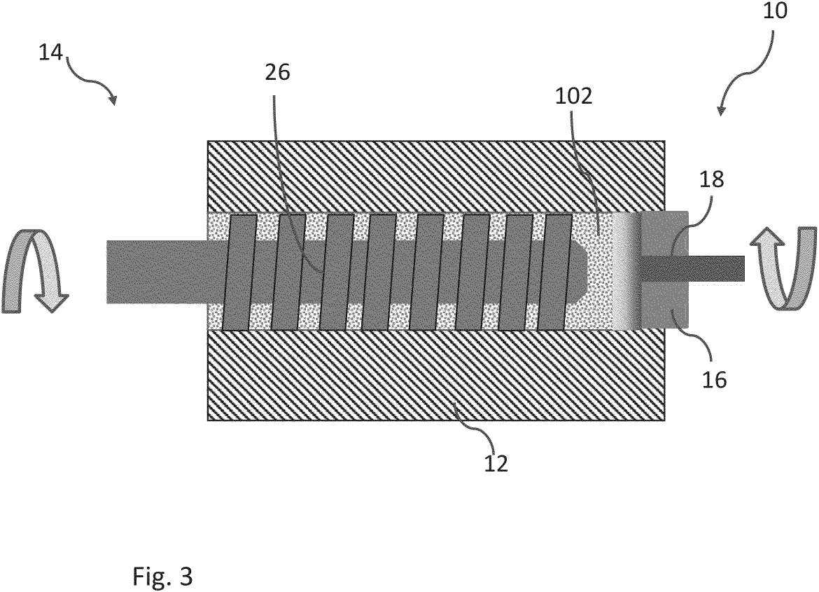

In some embodiments, as illustrated in FIG. 3, the propulsion system 14 can comprises a screw 26 that is configured to threadedly rotate and push the feedstock material 102 toward the friction die 16. In some embodiments, the screw and the friction die 16 rotate at different rates and/or directions.

Generally, any material, including metal, thermoplastic, composites, and edibles, that can be softened by temperature elevation can be used as a feedstock material 102 in accordance with the principles of the present teachings. In some embodiments, the feedstock material 102 is in the form of particles. In some embodiments, the feedstock material 102 is in the form of mixed particles. In some embodiments, the feedstock material 102 is in the form of mixed particles and carbon materials. In some embodiments, the feedstock material 102 is in the form of mixed particles and graphene. In some embodiments, the feedstock material 102 is in the form of mixed particles and fibers. In some embodiments, the feedstock material 102 is in the form of mixed particles and nanotubes. In some embodiments, the feedstock material 102 is in the form of a bar. In some embodiments, the feedstock material 102 comprise a hollow tube filled with other materials. In some embodiments, the material filled in the hollow tube is in the form of a solid bar, particles, mixed particles, a mixture of particles and nanotubes, a mixture of particles and fibers, a mixture of particles and graphene, or a mixture of some of these items. New materials and/or new composites can be manufactured from these feedstock materials using the manufacturing methods of the present teaching.

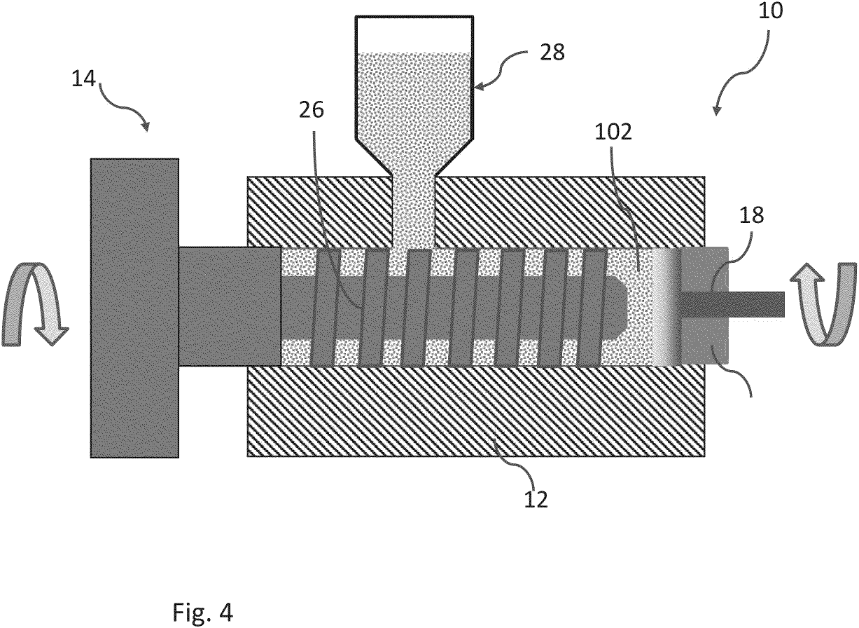

In some embodiments, the feedstock material 102 can be feed into the sleeve 12 from one end of the sleeve 12 (FIGS. 1, 2 and 3). In some embodiments, the feedstock material 102, such as in the form of particles, can be feed via an input orifice formed in a wall of the sleeve 12. In some embodiments, the feedstock material 102, such as in particle form, can be feed into the sleeve 12 through at least one hopper 28 connected to the wall of the sleeve 12 (FIG. 4).

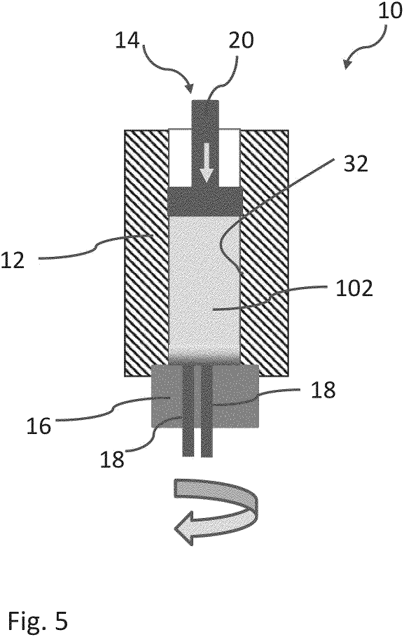

In some embodiments, the feedstock material 102 is extruded out of the sleeve 12 through at least one extrusion hole 18 in the friction die 16. In some embodiments, the feedstock material 102 is extruded out of the sleeve 12 through only one extrusion hole 18 in the friction die 16 (FIG. 1). In some embodiments, the feedstock material 102 is extruded out of the sleeve 12 through multiple extrusion holes in the friction die 16 (FIG. 5). In some embodiments, the feedstock material 102 is extruded out of the sleeve 12 through an extrusion holes in the center of the friction die 16 (FIG. 1). In some embodiments, the feedstock material 102 is extruded out of the sleeve 12 through an extrusion holes that is not in the center of the friction die 16 (FIG. 5).

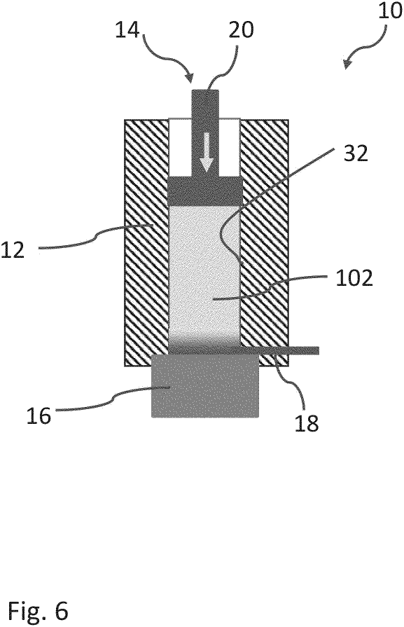

In some embodiments, the feedstock material 102 is extruded out of the sleeve 12 through at least one extrusion hole 18 in the wall of the sleeve 12. In some embodiments, the feedstock material 102 is extruded out of the sleeve 12 through one extrusion hole 18 in the wall of the sleeve 12 (FIG. 6). In some embodiments, the feedstock material 102 is extruded out of the sleeve 12 through multiple extrusion holes in the wall of the sleeve 12.

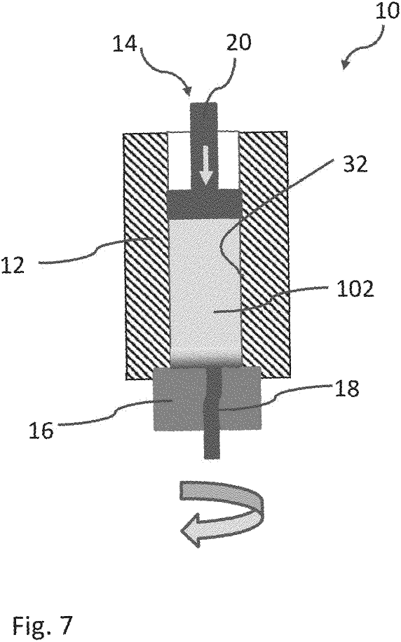

In some embodiments, at least one extrusion hole 18 is a round hole. In some embodiments, at least one extrusion hole 18 is not round. In some embodiments, the extrusion hole 18 can be a complex shape. In some embodiments, the extrusion hole 18 is a straight hole. In some embodiments, at least one extrusion hole 18 is a winding channel (FIG. 7).

The friction die 16 can be made of any materials that is strong enough at both room and elevated temperatures, including but not limited to tool steels, super alloys, carbide alloy, refractory alloys, composites, and ceramics.

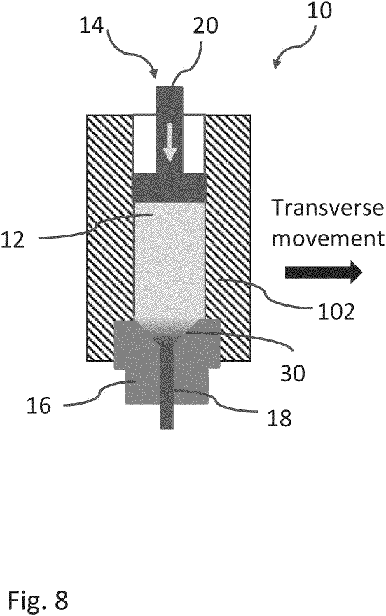

The shape of the friction die 16 can be a circular plate (in cross-section), but, in some embodiments, can be any shape that is conductive to the particular application. In some embodiments, the surface of the friction die 16 against the feedstock material 102 is flat. In some embodiments, the surface of the friction die 16 against the feedstock material 102 is in a concave shape. In some embodiments, hole 18 can comprise a chamfer 30 applied for at least one of the extrusion holes to ensure a complete flow of feedstock material 102 (FIG. 8).

In addition to a smooth surface, different features can be added on the surface of the friction die 16 to enhance the friction and resultant heating. In some embodiments, features can be added on the surface of the friction die 16 against the feedstock material 102. In some embodiments, the surface of the friction die 16 against the feedstock material 102 includes grooves. In some embodiments, the surface of the friction die 16 against the feedstock material 102 comprises protrusions. In some embodiments, the surface of the friction die 16 against the feedstock material 102 comprises dents to increase the surface roughness and therefore enhance the friction and resultant heating.

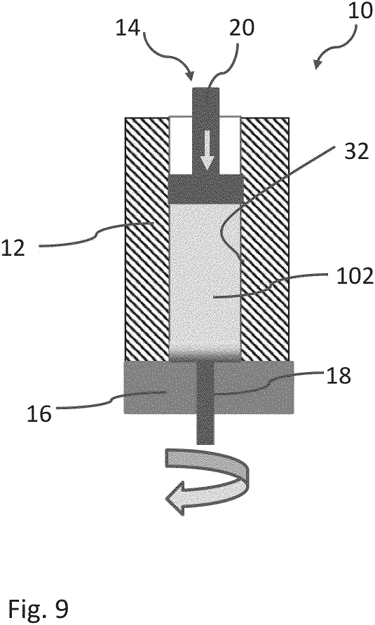

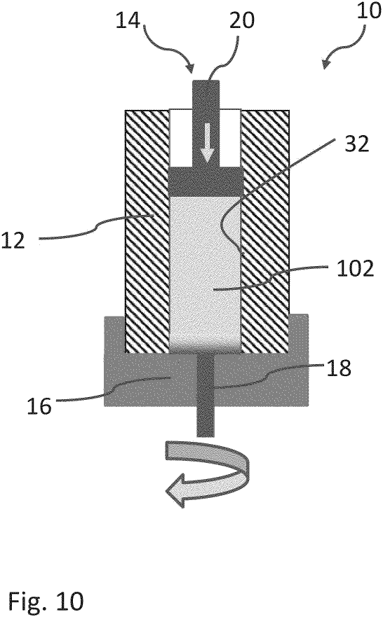

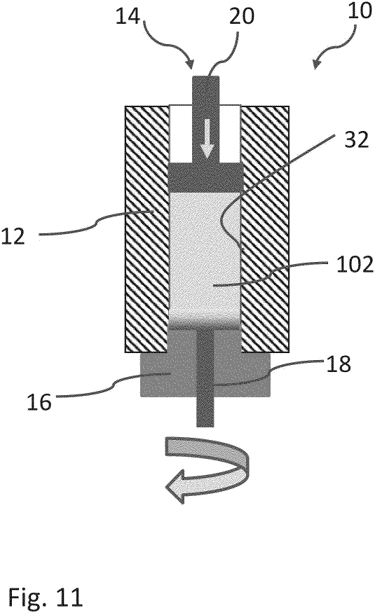

The combination between the sleeve 12 and the friction die 16 can be in various ways. An untighten contact between the sleeve 12 and the friction die 16 should be allowable to enable the relative rotation. A gap between the sleeve 12 and friction die 16 should be minimized to ensure that malleable feedstock material 102 is not inadvertently extruded therefrom. In some cases, an extrusion hole 18 may locate in between the friction die 16 and the sleeve 12, but this kind of extrusion hole 18 cannot be considered as the gap between the sleeve 12 and the friction die 16, but rather an extrusion hole. In some embodiments, one end of the sleeve 12 contacts directly against the friction die 16. In some embodiments, bushings are used in between the sleeve 12 and the friction die 16. In some embodiments, an end of the sleeve 12 sits on the surface of the friction die 16 (FIG. 9). In some embodiments, an end of the sleeve 12 sits in the friction die 16 (FIG. 10). In some embodiments, one or more parts of the friction die 16 are within the sleeve 12 (FIG. 11), or vice versa.

The sleeve 12 can be made of any materials that is strong enough at both room and elevated temperatures, including but not limited to carbon steel, tool steels, super alloys, carbide alloy, refractory alloy, composites, and ceramics. Sleeve 12 can comprise a hollow cavity 32. Hollow cavity 32 can have a circular or a non-circular cross section. In some embodiments, the hollow cavity 32 can comprise a rectangular cross section. In some embodiments, one or more parallel features can be added on the wall of the sleeve 12 to prohibit rotation of the feedstock material 102 relative to the sleeve 12.

“Locally Energized Extrusion” systems and methods can be further developed into more complex solid-state manufacturing systems and methods. Since the material 102 extruded out of the extrusion hole 18 are in a hot malleable state, the extruded material can be subjected to further materials processing for the purpose of shaping, additive manufacturing, filling a defect, etc.

Any variation for “Locally Energized Extrusion” mentioned above is also applicable to the solid-state manufacturing process developed thereafter.

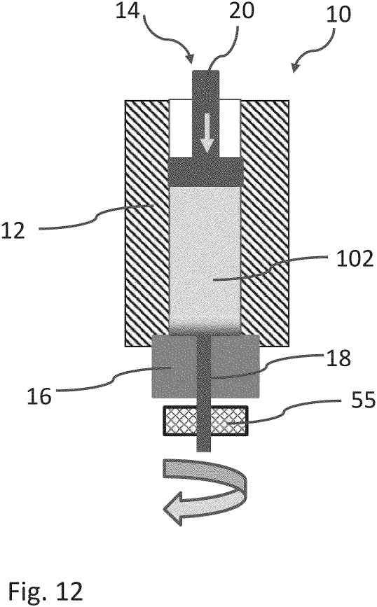

In some embodiments, a solid-state manufacturing methods and system comprises at least one sleeve 12, one propulsion system 14 located at the other end of the sleeve 12, one friction die 16 at one end of the sleeve 12, one extrusion hole 18 that allows the feedstock material 102 within the sleeve 12 be extruded out and one secondary material processing system 55 that can further process the extruded material (FIG. 12). The friction die 16 and the sleeve 12 solely rotate relative to each other but without a relative movement along the rotational axis direction between them. The propulsion system 14 pushes the feedstock material 102 toward the friction die 16 along the rotational axis direction. During processing, the relative friction between the friction die 16 and the feedstock material 102 within the sleeve 12 locally heats up the feedstock material 102 and brings the feedstock material 102 to a malleable state prior to extrusion. The malleable feedstock material 102 is extruded out of the sleeve 12 through at least one extrusion hole 18 under the action of the propulsion system 14. The material that was extruded out of the extrusion hole 18 can be subjected to further material processing by a secondary materials processing system 55. In some embodiments, the friction die 16 and the sleeve 12 solely rotate relative to each other.

In some embodiments, the secondary material processing system 55 can be a plastering surface 19. The solid-state processing system and method can be a SoftTouch deposition system and method. The SoftTouch deposition system and method comprises at least one sleeve 12, one friction die 16 at one end of the sleeve 12, one propulsion system 14 located at the other end of the sleeve 12, one extrusion hole 18 that allows the feedstock material 102 within the sleeve 12 to be extruded out of the sleeve 12, and one deposition surface that can deposit the extruded material on a substrate 104. The friction die 16 and the sleeve 12 rotate relative to each other but without a relative movement along the rotational axis direction between them. The feedstock system pushes the feedstock material 102 toward the friction die 16 along the rotational axis direction. During processing, the relative friction between the friction die 16 and the feedstock material 102 within the sleeve 12 locally heats up the feedstock material 102 and bring the feedstock material 102 to a malleable state prior to extrusion. The malleable feedstock material 102 is extruded out of the sleeve 12 through at least one extrusion hole 18 under the action of the propulsion system 14. The last step is to deposit the extruded material onto a substrate 104 by at least one plastering surface 19. In some embodiments, the plastering surface 19 can be one surface of the friction die 16.

SoftTouch deposition enable a relative low deposition force on the deposited material during deposition while maintaining a high deposition quality. There is no restriction on applying higher deposition force during deposition for some applications.

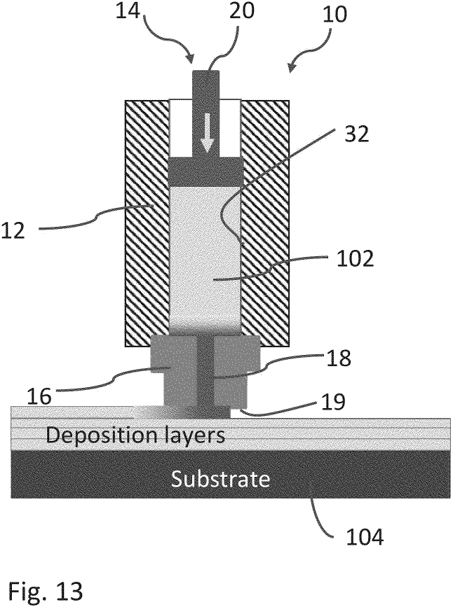

In some embodiments, “to deposit the extruded material onto a substrate” comprises to deposit the extruded material on at least one surface of a substrate 104 (FIG. 13).

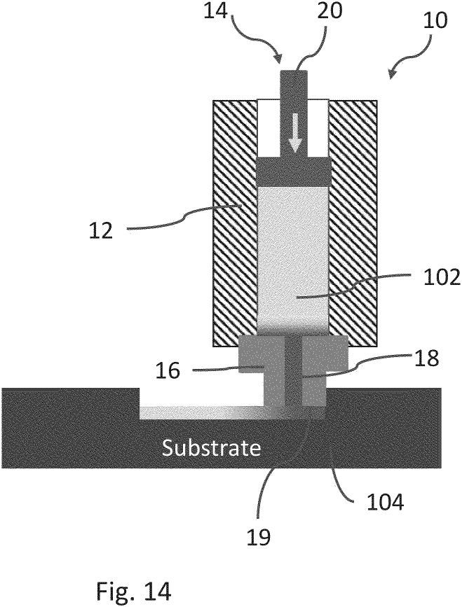

In some embodiments, “to deposit the extruded material onto a substrate” comprises to deposit the extruded material into at least one defect in a substrate 104 (FIG. 14). The defect can be any one of a dent, a groove, or a crack.

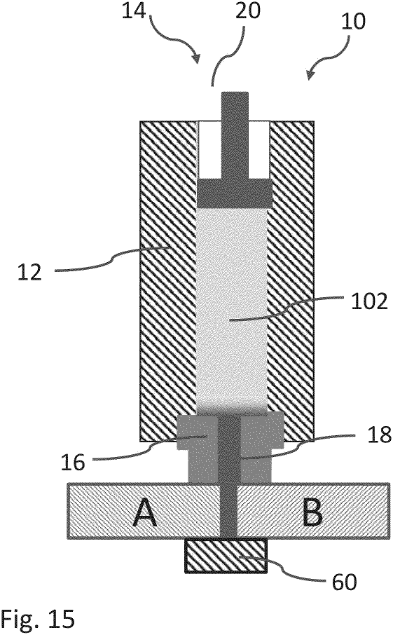

In some embodiments, “to deposit the extruded material onto a substrate” comprises to deposit the extruded material into at least one gap between at least two components to join the components together (FIG. 15). In some embodiments, a bottom shoulder 60 is used to increase the robustness of the joining processing. In some embodiments, a bottom shoulder 60 is rigidly connect to the manufacturing system 10 by a “C” frame. In some embodiments, the components need to be joined was placed on a strong backing plate.

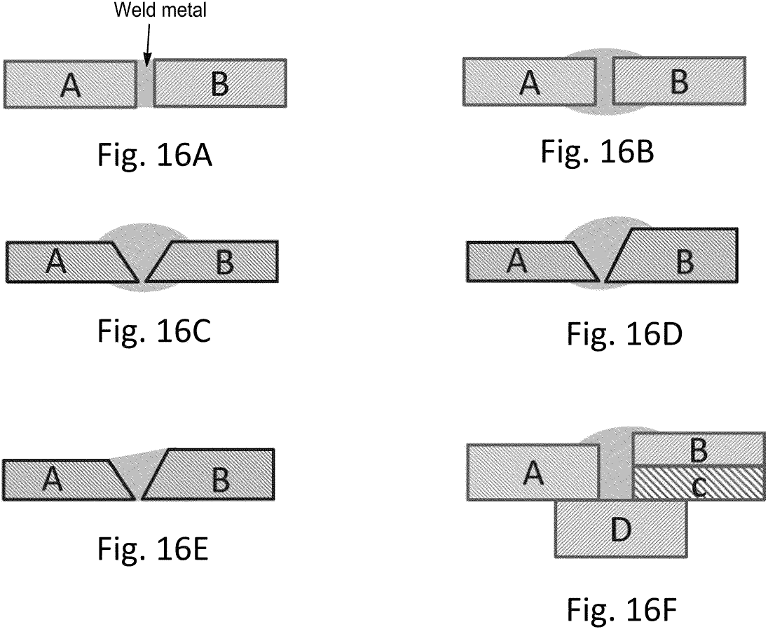

In some embodiments, the deposited material can be used to fill a gap between component A and component B (FIGS. 16A-16F). In some embodiments, component A and component B are the same material. In some embodiments, component A and component B are different materials. In some embodiments, the gap was fully filled by the deposited material (FIG. 16A). In some embodiments, the gap was over filled by the deposited material (FIG. 16B). In some embodiments, “V” shaped gap was made to facilitate the filling (FIG. 16C). In some embodiments, the thickness of components A and B are different (FIG. 16D). In some embodiments, the filled metal serves as a smooth transition zone between components A and B that are different in thickness (FIG. 16E). In some embodiments, the deposited material can be used to fill a gap among multiple components (FIG. 16F).

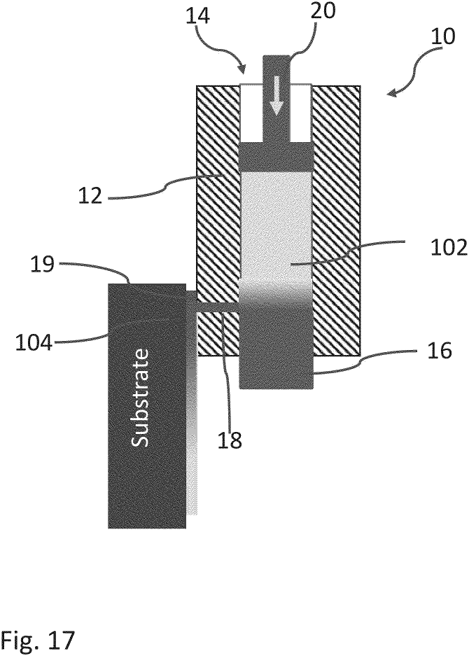

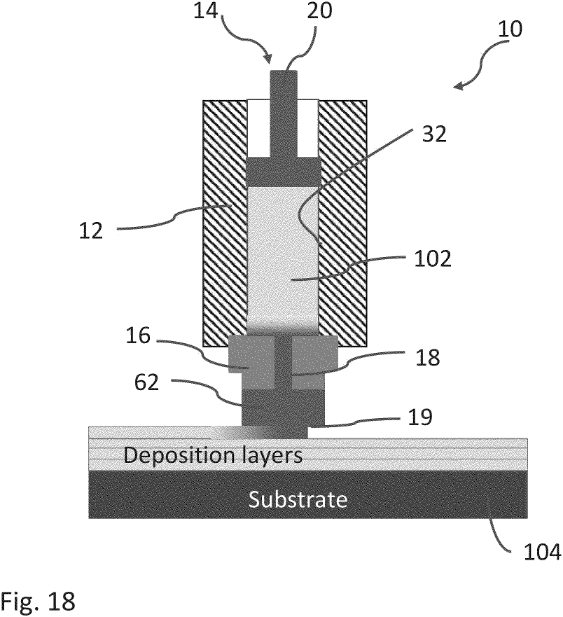

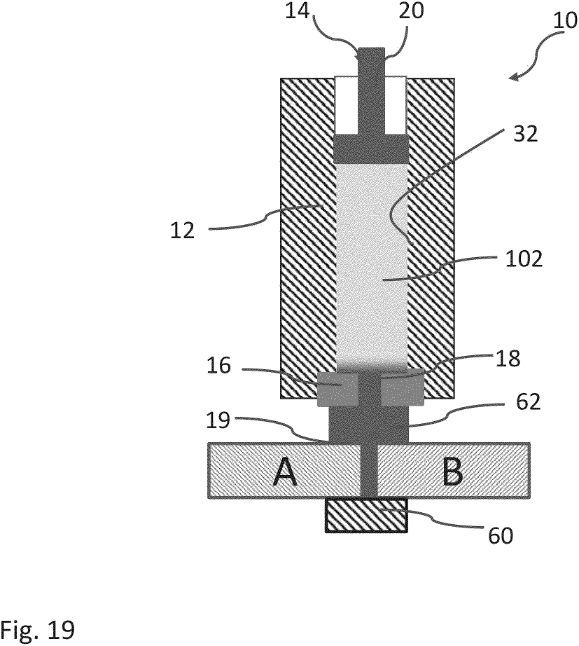

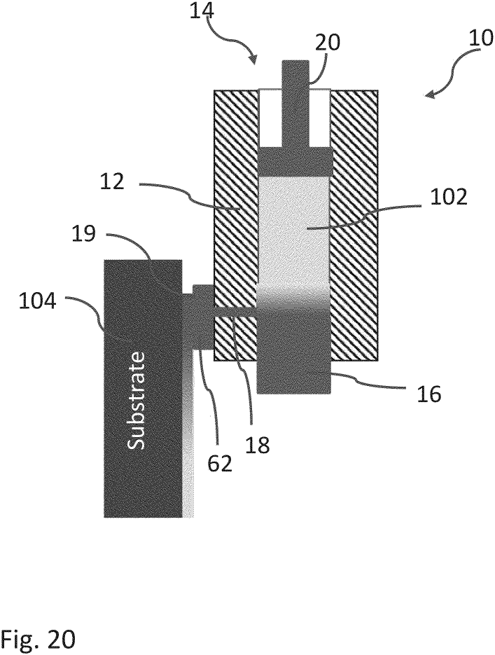

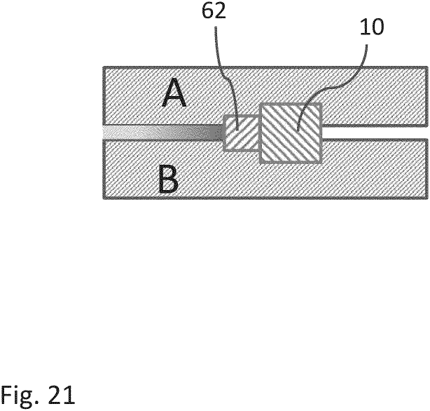

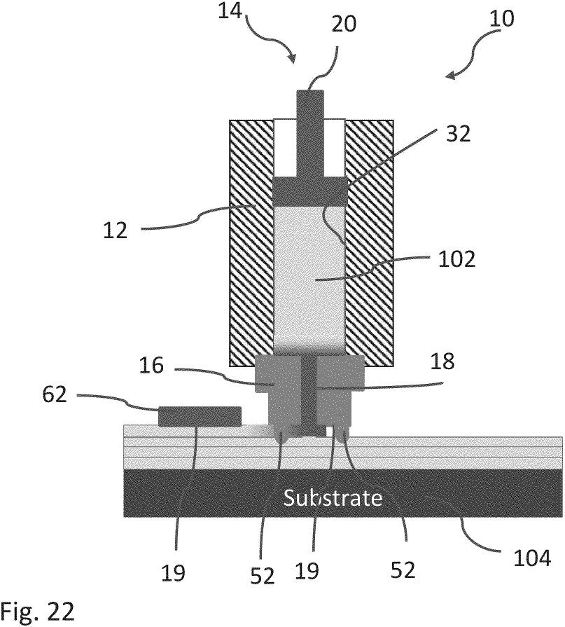

In some embodiments, the plastering surface 19 is one surface the friction die 16 (FIG. 13). In some embodiments, the plastering surface 19 is on the surface the sleeve 12 (FIG. 17). In some embodiments, the plastering surface 19 is located on a surface of a forming tool 62. In some embodiments, the forming tool 62 is located in between the extrusion die and the deposited material (FIGS. 18 and 19). In some embodiments, the forming tool 62 is located in between the sleeve 12 and the deposited material 102 (FIG. 20). In some embodiments, the forming tool 62 is located behind the extrusion hole 18 (FIGS. 21, 22).

In some embodiments, more than one plastering surface can be used for better control of the deposited material. In some embodiments, one plastering surface 19 is one surface of friction die 16 and another plastering surface 19 is the surface of a forming tool 62 (FIG. 22). In some embodiments, one plastering surface is on the surface of sleeve 12 and another plastering surface 19 is on the surface of a forming tool 62.

In some embodiments, the plastering surface 19 is flat. In some embodiments, the plastering surface 19 was processed to different shaped to achieve more a complicated deposition appearance. In some embodiments, the plastering surface 19 is smooth to get a smooth deposition surface. In some embodiments, the plastering surface 19 is rough to prompt deformation of the deposited material. In some embodiments, the plastering surface 19 comprises protrusions 52 to improve the deformation of the deposited materials (FIG. 22). In some embodiments, the protrusions 52 on plastering surface 19 is longer than the thickness of the deposited layer and improve the mixture of the deposited materials between layers (FIG. 22).

In some embodiments, the plastering surface 19 can complete a deposition without a traverse movement relative to the substrate 104 to be deposited on (FIG. 17). In some embodiments, the plastering surface 19 traverses relative the substrate to be deposited on and deposits at least one layer of material 102 on the substrate 104 (FIG. 14). In some embodiments, the plastering surface 19 moves transversely and vertically relative to the substrate to be deposited on and deposits multiple layers of material 102 on the substrate 104 until a desired shape has been achieved.

In some embodiments, the SoftTouch deposition system was installed on a robotic arm to produce more complicates shape. In some embodiments, the SoftTouch deposition system can also be installed on other machine body that allow the movement of the deposition surface in various directions.

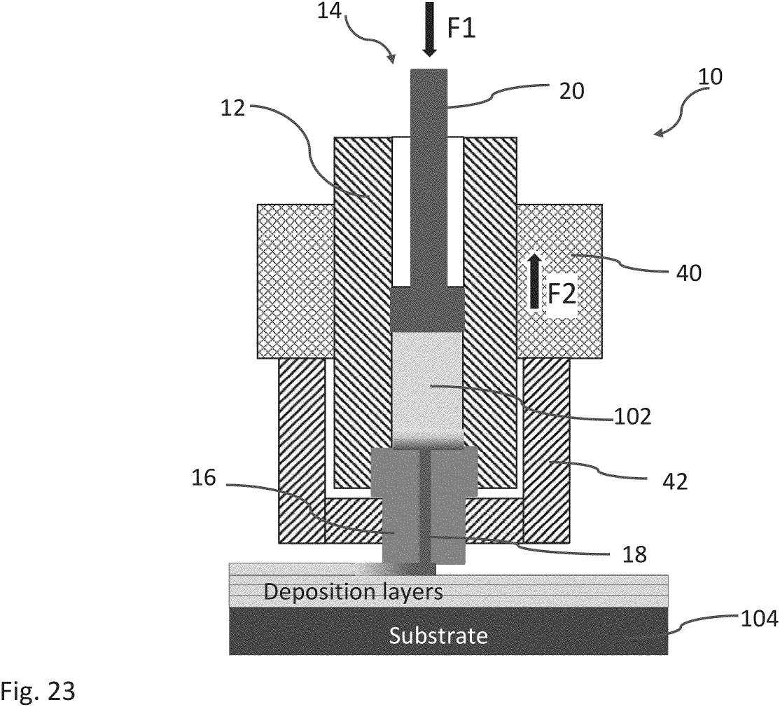

In some embodiments, as illustrated in FIG. 23, a pushing force (F1) can be applied to feedstock material 102 via a push ram (propulsion system 14). A relative lower pull force (F2) can be applied on a rotatory hollow spindle 40, which has a rigid connection (e.g. linkage system 42) with the friction die 16. The overall forging force applied to the deposition region is equal to the difference between F1 and F2.

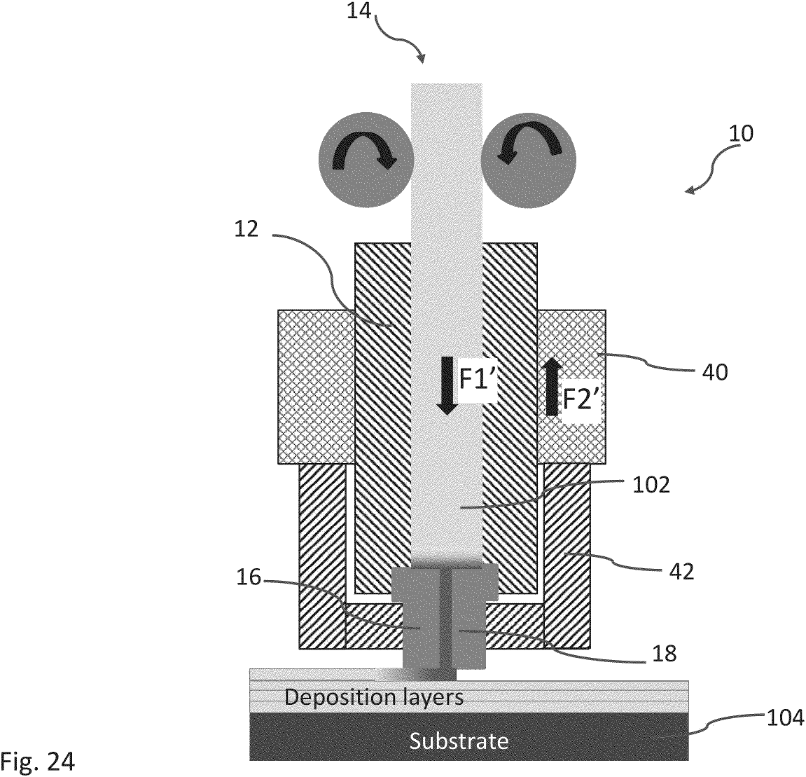

In some embodiments, as illustrated in FIG. 24, the push force (F1′) applied to feedstock material 102 can be achieved through a rolling system (propulsion system 14). A relative lower pull force (F2′) can be applied on the rotatory hollow spindle 40, which has a rigid connection (e.g. linkage system 42) with the friction die 16. The overall forging force applied to the deposition region is equal to the difference between F1′ and F2′.

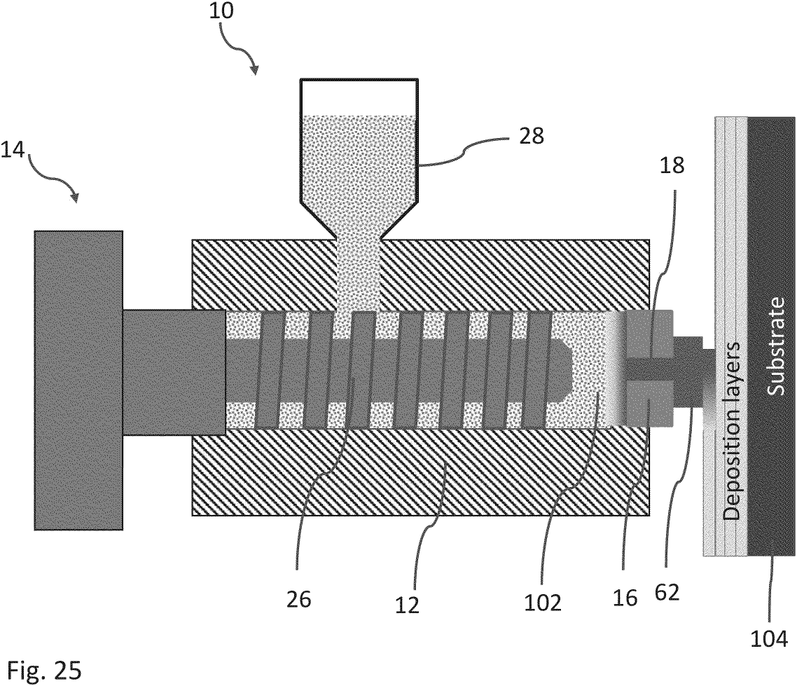

In some embodiments, as illustrated in FIG. 25, the feedstock material 102 in particles form were feed into the sleeve 12 by hopper 28 and then pushed toward the rotating friction die 16 by a rotating screw. The screw and the friction die 16 rotate at different speeds or direction. Such arrangements allow continual feeding of the feedstock material 102 and a continual extrusion of the material out of the extrusion die for deposition. An optional forming tool 62 can be used to customize the quality of the deposition.

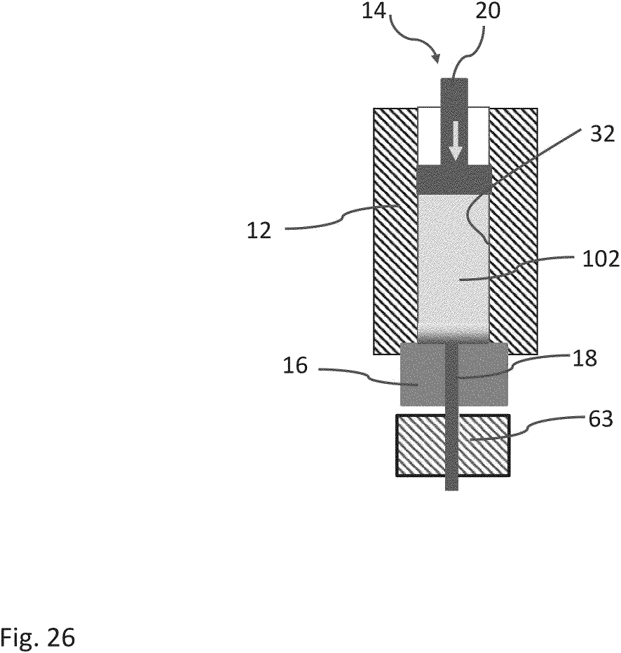

In some embodiments, as illustrated in FIG. 26, the secondary material processing system 55 of solid-state manufacturing system includes a secondary thermomechanical processing system 63.

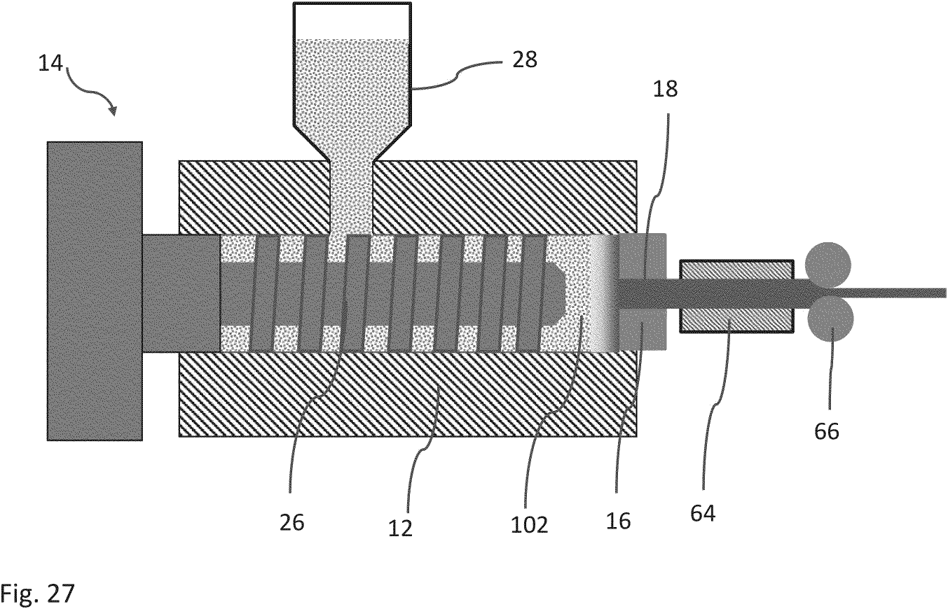

In some embodiments, as illustrated in FIG. 27, the secondary thermomechanical process system 63 comprises a rolling system 66. An optional temperature control system 64 (such as a cooling system) can be used ahead of the rolling system 66.

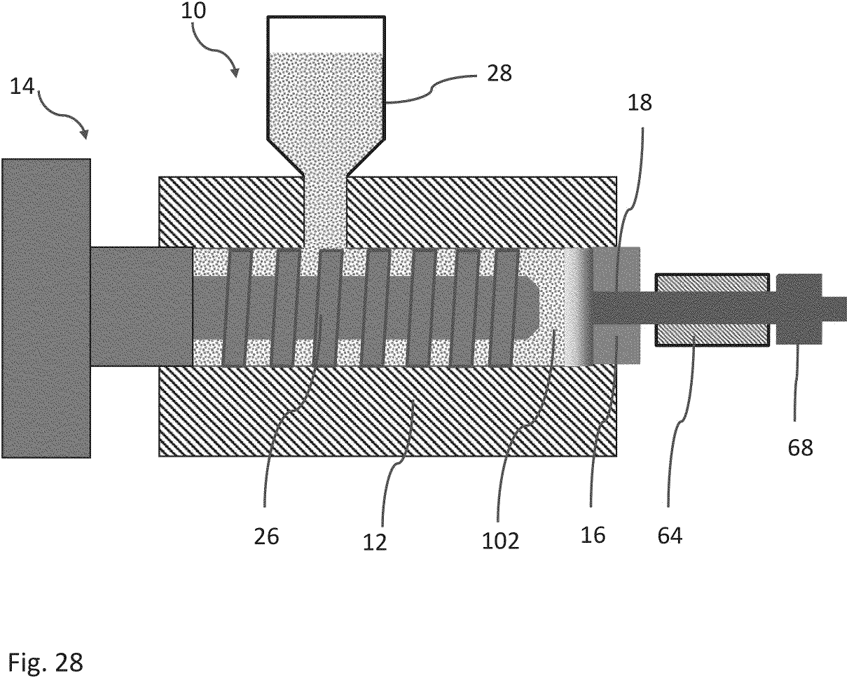

In some embodiments, as illustrated in FIG. 28, the secondary thermomechanical process system 63 comprises an extrusion system 68. An optional temperature control system 64 (such as an induction heating coil) can be used ahead of the extrusion.

In some embodiments, the secondary thermomechanical process 63 system comprises a forming system.

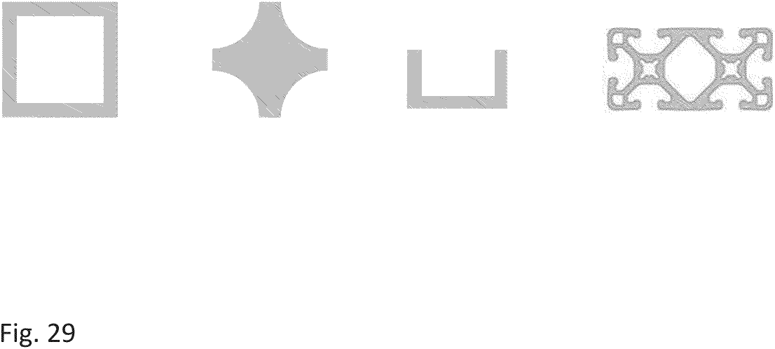

In some embodiments, as illustrated in FIG. 29, the cross-section of the material 102 that is extruded out by the solid-state manufacturing system can be in a simple square frame or more complicated shapes.

In order to improve the tool life or further improve the quality of the material extrusion, deposition, and material processing, a temperature control system may be applied to the sleeve 12 and the friction die 16. In some embodiments, one or multiple cooling channels is added to the friction die 16. In some embodiments, a heating system is added around the sleeve 12. The heating can be achieved by a conventional means.

Advantages and improvements of the SoftTouch over existing methods include a higher deposition speed; reduced manufacturing cost; suitability for metals, polymers, and composites; suitability for automation and robotic applications; applicability to additive manufacturing, coating, defect repairing, and joining; applicability to manufacturing multi-material structures; applicability for amorphous coating; no bulk meting during the process; produced parts having equiaxed fine-grained wrought microstructure (the result of thermomechanical processing and recrystallization) rather than cast structure (the result of solidification from the liquid); produced parts having fully dense microstructure and free of pore defects, high mechanical properties and corrosion resistance; can be an open-to-atmosphere process; no special vacuum and chamber is needed for operation making it a safer, more efficient and fully scalable technology; and minimum energy consumption and environmental-friendliness.

The foregoing description of the embodiments has been provided for purposes of illustration and description. It is not intended to be exhaustive or to limit the disclosure. Individual elements or features of a particular embodiment are generally not limited to that particular embodiments, but, where applicable, are interchangeable and can be used in a selected embodiments, even if not specifically shown or described. The same may also be varied in many ways. Such variations are not to be regarded as a departure from the disclosure, and all such modifications are intended to be included within the scope of the disclosure.

What is claimed is:

1. A solid-state manufacturing method comprising:
urging a metal-based feedstock material within a sleeve of a propulsion system in a processing direction along an axis of the sleeve and against a friction die adjacent one end of the sleeve;
softening at least a portion of the feedstock material within the hollow portion of the sleeve to a malleable state to form malleable feedstock material using relative rotatory friction between the friction die and the feedstock material;
extruding the malleable feedstock material from an extrusion hole in response to the urging step; and
depositing the malleable feedstock material from the extrusion hole onto a substrate as a paste using at least one plastering surface and continuing depositing the malleable feedstock material as deposit layers until a desired shape is completed.

2. The solid-state manufacturing method according to claim 1, wherein the step of softening at least a portion of the feedstock material within the hollow portion of the sleeve to a malleable state to form malleable feedstock material using relative rotatory friction between the friction die and the feedstock material further comprises locally softening the feedstock material to a malleable state prior to the step of depositing by heating using the relative rotatory friction and microstructure refinements formed via thermomechanical processing and recrystallization.

3. The solid-state manufacturing method according to claim 1, wherein the friction die contains at least an extrusion hole allowing the malleable feedstock material to be extrude out of the sleeve and deposited in response to the urging step.

4. The solid-state manufacturing method according to claim 1, wherein the deposit layers are fully dense.

5. The solid-state manufacturing method according to claim 1, wherein the step of urging a metal-based feedstock material comprises urging a metal-based feedstock material in the form of particles.

6. The solid-state manufacturing method according to claim 1, wherein the step of urging a metal-based feedstock material comprises urging a metal-based feedstock material in the form of mixed particles and carbon materials.

7. The solid-state manufacturing method according to claim 1, wherein the step of urging a metal-based feedstock material comprises urging a metal-based feedstock material in the form of mixed particles and fibers.

8. The solid-state manufacturing method according to claim 1, wherein the step of urging a metal-based feedstock material comprises urging a metal-based feedstock material in the form of a bar.

9. The solid-state manufacturing method according to claim 1, wherein the step of urging a metal-based feedstock material comprises urging a metal-based feedstock material in the form of a hollow tube filled with other materials.

10. The solid-state manufacturing method according to claim 1, wherein a surface of the friction die against the feedstock material is flat.

11. The solid-state manufacturing method according to claim 1, wherein a surface of the friction die against the feedstock material is in a concave shape.

12. The solid-state manufacturing method according to claim 1, wherein a surface of the friction die against the feedstock material comprises dents to increase surface roughness and friction heating.

13. The solid-state manufacturing method according to claim 1, wherein a surface of the friction die against the feedstock material comprises grooves.

14. The solid-state manufacturing method according to claim 1, wherein a surface of the friction die against the feedstock material comprises protrusions.

15. The solid-state manufacturing method according to claim 1, wherein the plastering surface against the deposit layers is one surface of the friction die.

16. The solid-state manufacturing method according to claim 1, wherein the plastering surface against the deposit layers is one surface of a forming tool to improve surface quality of the deposit layers.

17. The solid-state manufacturing method according to claim 1, wherein the plastering surface against the deposit layers is smooth to produce a smooth deposition surface.

18. The solid-state manufacturing method according to claim 1, wherein the plastering surface against the deposit layers comprises protrusions to improve the deformation of the deposited materials.

19. The solid-state manufacturing method according to claim 18, wherein the protrusions are each longer than the thickness of the deposit layers for improving the mixture of the deposited material between deposit layers.
